(19) United States
(12) Patent Application Publication
(10) Pub. No.: US 2002/0165781 A1
(43) Pub. Date: Nov. 7, 2002

(54) Interactive media management system and method for network applications

(76) Inventor: Brent McKay, Aliso Viejo, CA (US)

Correspondence Address: STRADLING YOCCA CARLSON & RAUTH, IP Department, Suite 1600, 660 Newport Center Drive, P.O. Box 7680, Newport Beach, CA, 92660-6441, US

(21) Appl. No.: 10/004,281

(22) Filed: Oct. 31, 2001

Related U.S. Application Data
(60) Provisional application No. 60/244,761, filed on Oct. 31, 2000.

(51) Int. Cl. G06F 17/60

(52) U.S. Cl. 705/22; 705/28

(57) ABSTRACT

A media management system has a web-based interface configured to provide substantially real-time media pricing, provide substantially real-time media availability, and facilitate substantially real-time buying of media.

### PRIORITY CLAIM

This patent application claims the benefit of the filing date of the U.S. Provisional Patent Application Serial No. 60/244,761, filed Oct. 31, 2000 and entitled INTERACTIVE MEDIA MANAGEMENT SYSTEM AND METHOD FOR NETWORK APPLICATIONS, the entire contents of which are hereby expressly incorporated by reference.

### FIELD OF THE INVENTION

The present invention relates generally to web-based interfaces. The present invention relates more particularly to a web-based interface for facilitating the development and deployment of advertising campaigns by media professionals.

### BACKGROUND OF THE INVENTION

The use of various different media, e.g., internet rnedia, television, radio, newspaper, magazine, billboards, etc., in advertising campaigns is well known. Typically, media professionals develop an advertising campaign wherein the type of media, the timing of the advertisements, and various other parameters are specifically designed so as to have the greatest possible impact on the target audience.

According to contemporary methodology, a advertising campaign comprises preparation, planning, buying and reporting in a traditional manner. First the advertiser develops intelligence regarding the customer target profile, e.g., identification of any known demographics, psychographics and geographic criteria which are believed to be relevant to the target market of the media campaign. This targeted consumer group information (referred to herein as a media plan profiled) is used as a basis for developing creative material and for allocating budgets to various advertising mediums in an effort to most effectively meet the desired objectives of the advertising campaign.

After defining the total budget, distribution of the budget across the various elected mediums, and after the medium plan profile information has been developed, then the media planning process commences. Media planners typically manually collect all data regarding the availability, pricing and various other pertinent information within a given advertising medium. The media planners then manually process this information so as to develop the media procurement plan. Media buys are then manually placed. In the case of large national media campaigns, the number of potential communication points required to gather such information can easily number in the hundreds or even thousands. For example, there are over 1,000 radio stations in the United States. Many, if not all, of these 1,000 radio stations would need to be contacted individually, typically multiple times, as part of a nationwide media planning/buying process.

Because the preparation and planning processes are extremely time consuming, there is an inherent time lag between the initially available information which is immediately collected, and provision of the same information when the media buyers are actually ready to purchase media. As a result of this inherent lag or time difference, there are frequently times when inventory is no longer available. This inavailability of desired media necessarily results in a reselection of media process, which undesirably complicates and extends the time required to implement a desired advertising campaign.

Reporting capabilities vary considerably between advertising mediums. Reporting capabilities also vary considerably between different suppliers within a given medium. Generally, such reporting capabilities are limited to an undesirably meager amount of post-buy statistics which show how many times the ad was run. All to frequently, even this small amount of information is unavailable for many months due to the length of time the campaign is actually run and due to the manual collection and reporting processes of the media supplier.

Further, contemporary media management utilizes a static pricing model wherein each piece of inventory is sold at a specific price, regardless of the means by which that particular piece of inventory was selected.

In view of the foregoing, it is desirable to provide a web-based management technology which allows media professionals to develop and deploy advertising campaigns in a more efficient and effective manner. It is further desirable that such technology be embedded into an inventory sales system for each media supplier. In this manner, the media supplier would be able to support on-line, real-time sales of media inventory through the web-based interface, and the media supplier could also utilize dynamic pricing models which are driven by the degree of target availability selected by the media buyer, rather than using only step pricing models.

### SUMMARY OF THE INVENTION

The present invention specifically addresses and alleviates the above-mentioned deficiencies associated with the prior art. More particularly, the present invention comprises a media management system comprising a web-based interface configured to provide substantially real-time media pricing, provide substantially real-time media availability and facilitate substantially real-time buying of media.

These, as well as other advantages of the present invention will be more apparent from the following description and drawings. It is understood that changes in the specific structure shown and described may be made within the scope of the claims without departing from the spirit of the invention.

### BRIEF DESCRIPTION OF THE DRAWINGS

FIG. 1 is a screen presentation for use by registered media professionals, such as media buyers, showing account information;

FIG. 2 is a screen presentation for use by registered media professionals, such as media buyers, showing price and availability information;

FIG. 3 is a screen presentation for use by registered media professionals, such as media buyers, showing price and availability information for a desired media type and seller;

FIG. 4 is a screen presentation for use by registered media professionals, such as media buyers, showing information regarding media type;

FIG. 5 is a screen presentation for use by registered media professionals, such as media buyers, showing information regarding sellers;

FIG. 6 is a screen presentation for use by registered media professionals, such as media buyers, showing information regarding brand;

FIG. 7 is a screen presentation for use by registered media professionals, such as media buyers, showing information regarding the time period;

FIG. 8 is a screen presentation for use by registered media professionals, such as media buyers, showing additional information regarding time period;

FIG. 9 is a screen presentation for use by registered media professionals, such as media buyers, showing information regarding location;

FIG. 10 is a screen presentation for use by registered media professionals, such as media buyers, showing geographic information;

FIG. 11 is a screen presentation for use by registered media professionals, such as media buyers, showing information regarding property type;

FIG. 12 is a screen presentation for use by registered media professionals, such as media buyers, showing information regarding tenant SIC code;

FIG. 13 is a screen presentation for use by registered media professionals, such as media buyers, showing information regarding store proximity;

FIG. 14 is a screen presentation for use by registered media professionals, such as media buyers, showing information regarding user demographics;

FIG. 15 is a screen presentation for use by registered media professionals, such as media buyers, showing further information regarding demographics;

FIG. 16 is a screen presentation for use by registered media professionals, such as media buyers, showing information regarding user psychographics;

FIG. 17 is a screen presentation for use by registered media professionals, such as media buyers, showing information regarding directory interactivity;

FIG. 18 is a screen presentation for use by registered media professionals, such as media buyers, showing information regarding purchasing;

FIG. 19 is a screen presentation for use by registered media professionals, such as media buyers, showing information regarding web interactivity;

FIG. 20 is a screen presentation for use by registered media professionals, such as media buyers, showing specifications;

FIG. 21 is a screen presentation for use by registered media professionals, such as media buyers, showing ad type;

FIG. 22 is a screen presentation for use by registered media professionals, such as media buyers, showing teaser type;

FIG. 23 is a screen presentation for use by registered media professionals, such as media buyers, showing teaser-link type;

FIG. 24 is a screen presentation for use by registered media professionals, such as media buyers, showing planning and buying information;

FIG. 25 is a screen presentation for use by registered media professionals, such as media buyers, showing information regarding reporting and managing;

FIG. 26 is a screen presentation for use by registered media professionals, such as media buyers, showing feedback;

FIG. 27 is a screen display for use by registered local advertisers, showing a system overview;

FIG. 28 is a screen display for use by registered local advertisers, showing advertising information; and

FIG. 29 is a screen display for use by registered local advertisers, showing feedback information.

### DETAILED DESCRIPTION OF THE INVENTION

The detailed description set forth below in connection with the appended drawings is intended as a description of the presently preferred embodiment of the invention, and is not intended to represent the only form in which the present invention may be constructed or utilized. The detailed description sets forth the construction and functions of the invention as well as the sequence of steps for operating the invention in connection with the illustrated embodiments. It is to be understood, however, that the same or equivalent functions may be accomplished by different embodiments that are also intended to be encompassed within the spirit and scope of the invention.

The media management system of the present invention automates the media management process and integrates the various components thereof into a single, web-based, interface or tool. The media management system of the present invention delivers real-time pricing and availability information. This real-time pricing and availability information can then be used to place real-time medial buys. The media management system of the present invention provides media planners with new tools which improve the effectiveness of their media purchasing plan and advertising campaign.

The media management system of the present invention also provides real-time monitoring of key information and performance statistics throughout the life of the advertising campaign. Such monitoring allows advertisers to fine tune or modify their campaign while the campaign is still in progress, so as to enhance the effectiveness thereof.

According to the present invention, the media management process includes preparation, planning, buying and reporting, as does the contemporary media management process. However, according to the present invention, these processes are highly automated in a manner which is both efficient and powerful, thereby resulting in significant, tangible economic results on many different levels.

A media plan profile is developed and entered into the web-based interface. The media plan profile comprises any desired combination of media planning variables, such as the desired types of media, the duration of the purchase, ad placement (such as time of day for radio and television and such as position with a periodical).

According to the planning process of the present invention, any combination of media planning variables is translated into pricing and availability for inventory for the media types which match the desired variables. The planning and process includes a real-time iterative process wherein modification and refinement of the plan is as simple as reselecting any of the desired media variables and making the desired changes thereto. The web-based interface recalculates and redisplays the revised pricing and availability information. Individual inventory specifics can then be assessed immediately so as to verify their appropriateness. Any inappropriate media can easily be excluded from the medial plan profile and any of the media plan profile parameters can easily be changed.

According to the present invention, once the desired media plan profile has been completed, purchasing of the desired inventory is as simple as sending an electronic purchase order to the selected media providers. Preferably, immediate confirmation of the purchase order can be so accomplished.

Optionally, the web-based interface also facilitates the electronic distribution of requests for proposals (RFP) to desired suppliers, i.e. those suppliers who have inventory which matches the media plan profile.

The web-based interface then coordinates all of the offers such that the appropriate offers are communicated back to the buyer or potential buyer. The web-based interface facilitates the purchases of any desired subset of those contained in such offers.

The present invention further facilitates reporting of pertinent variables. Such reporting can generally be accomplished at any desired time. Real-time results (or as close to real-time results as possible given the nature of the selected medium) are displayed for analysis. If modifications to the media campaign are desired then the web-based interface supports simple revision of the advertising campaign, even once the advertising campaign has commenced.

The web-based media management system of the present invention thus operates in a manner which is fundamentally different from the way that traditional media management occurs. The media management system of the present invention uses the information of a media plan profile as a basis for the deriving specific media plan which most accurately matches the parameters thereof. Utilizing the media management web-based user interface, media planners create a list of planned components (for example, campaign flight dates, target income ranges, and age groups, geographic locations, and occupational preferences) which reflect the target consumer group for the product or service being marketed. This group of planned components creates a digital media plan profile which the web-based interface uses to facilitate mapping into all available suppliers from all available mediums who cooperate with the web-based interface, such as by utilizing embedded technology in their medium sales and/or inventory systems.

Thus, the medium management system of the present invention results in a real-time filter which immediately retrieves inventories, such that the retrieved inventories match the media plan profile. A reporter provides reports such as summary statistics on media reach and impressions generated and a processor calculates pricing based on either a static or dynamic pricing model or a combination of static and pricing models. The media plan specification can be fine tuned or modified, such as using an immediate feedback loop which provides real-time impact on changes in the variables set, thus resulting in and optimum combination of targeting and media value.

The media management system of the present invention thus provides a substantial mitigation in the amount of time and resources required to manage the media planning and implementation process of an advertising campaign.

Further, the media planner of the present invention more accurately maps the media campaign into the target group of consumers, because the media management system of the present invention is able to process hundreds of thousand or even millions of pieces of relevant information and is capable of returning an immediate result. This is well beyond the capability of the contemporary media management process.

Thus, while the contemporary media management process is able to only consider a very small subset of potential media outlets and is only capable of delivering an advertising campaign to a less, than optimal set of consumers as a result. Alternatively, contemporary media managers may obtain better results, however, in order to do so they would be required to pay much more than would users of the present invention.

According to the present invention, planners can effectively look at the impact of cross-media variables and tune the allocation between mediums rather than use rough historical guidelines to develop an allocation strategy.

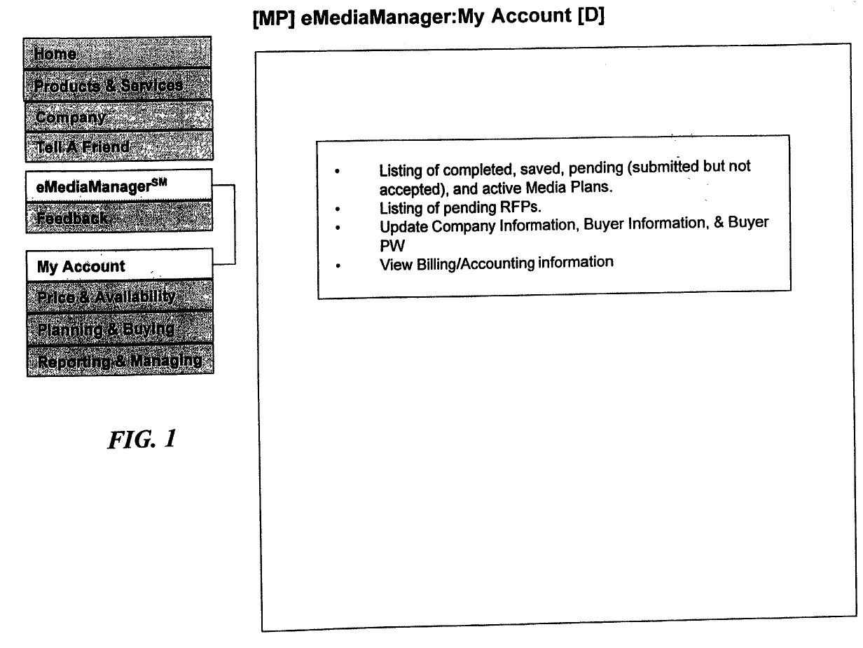

FIGS. 1-26 show screen presentations of the interactive media management system interface of the present invention for use by media professionals, such as media purchasers. As used herein, registered media professionals are media professionals who have registered to use the interactive media management system of the present invention and who have been granted access thereto.

Referring now to FIG. 1, a screen presentation showing account information for the media professional is provided. This screen lists completed, saved, pending (submitted but not accepted) and active media plans. If requests for proposals are facilitated, then a list of pending requested proposals is also shown. Optionally, the screen also shows updated company information, buyer information, and buyer password (PW). This screen also optionally facilitates viewing of billing/accounting information.

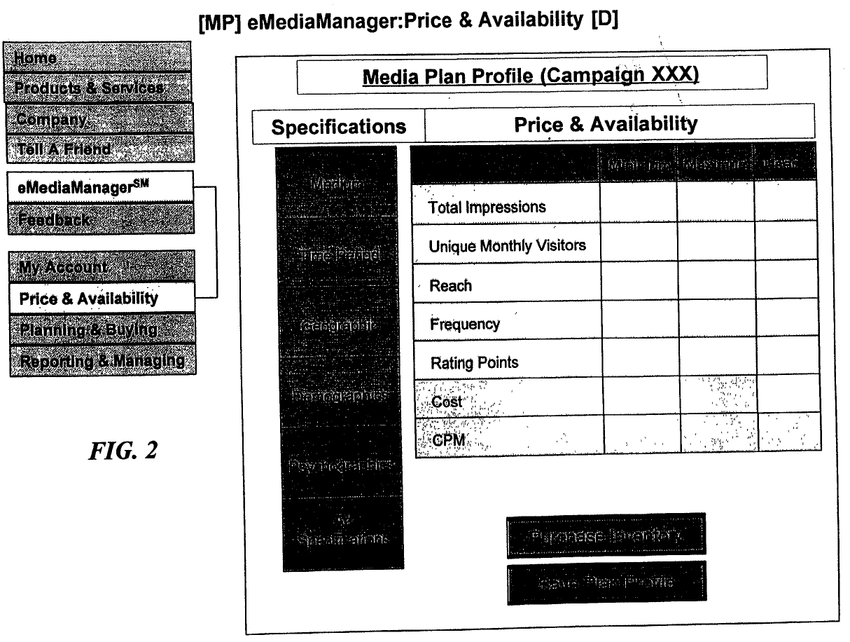

Referring now to FIG. 2, a screen presentation showing price and availability is provided. This screen preferably facilitates the listing of the minimum, maximum, and user amounts for total impressions, unique monthly visitors, reach, frequency, rating points, cost and cost per thousand (CPM). This screen also preferably facilitates purchasing of inventory and the saving of a desired plan profile.

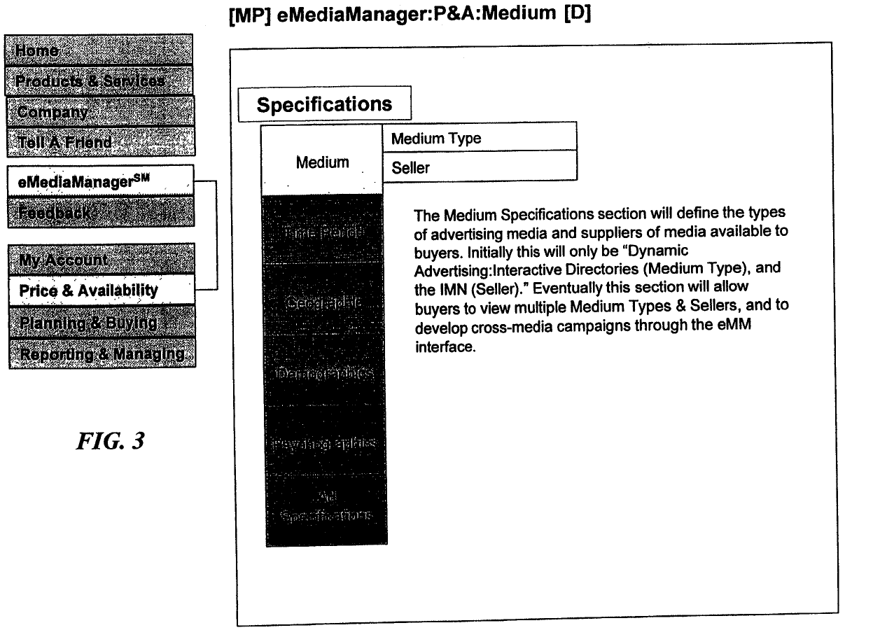

Referring now to FIG. 3, a screen presentation which shows information regarding the media type is provided. The media specification selections will define the types of advertising media and suppliers available to buyers. Both dynamic advertising utilizing interactive directories and multiple media types and sellers may be viewed. The ability to view media types and sellers facilitates the development cross-media campaigns through the interface of the present invention.

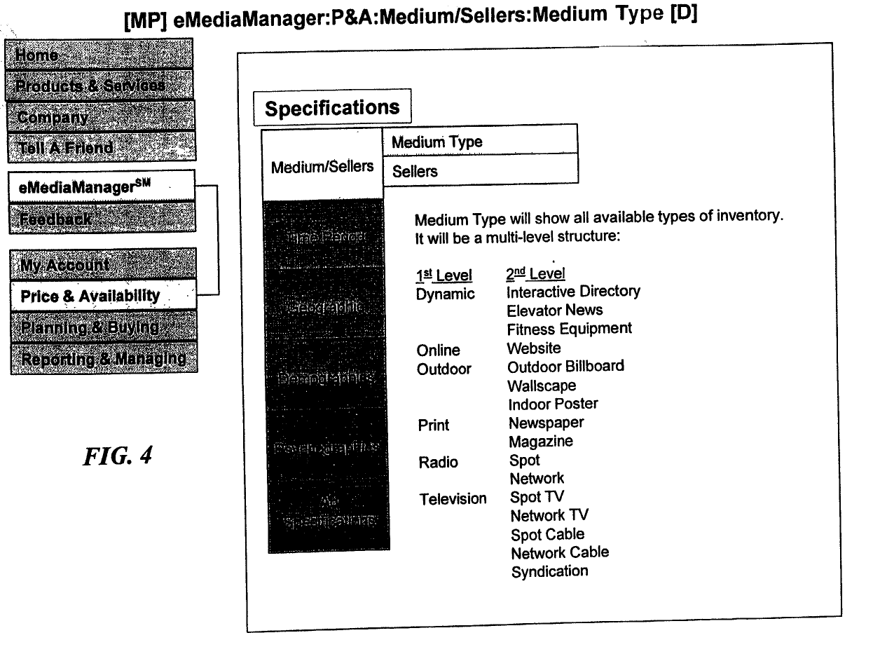

Referring now to FIG. 4, a screen presentation showing information regarding the media type is provided. The media type indicates all available types of inventory. The media type is preferably a multi-level structure wherein the first level indicates an attribute of the media, such as whether the media type is online or outdoor and the second level indicates a more particular attribute of the media type, such as whether the media is a website or an outdoor billboard.

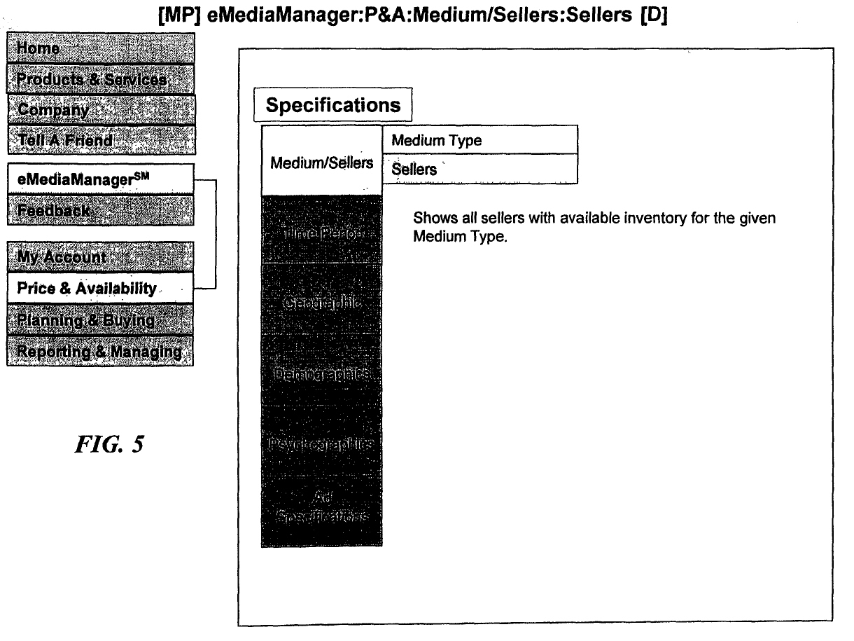

Referring now to FIG. 5, a screen presentation showing seller information is provided. The screen shows all sellers with available inventory for a given media type.

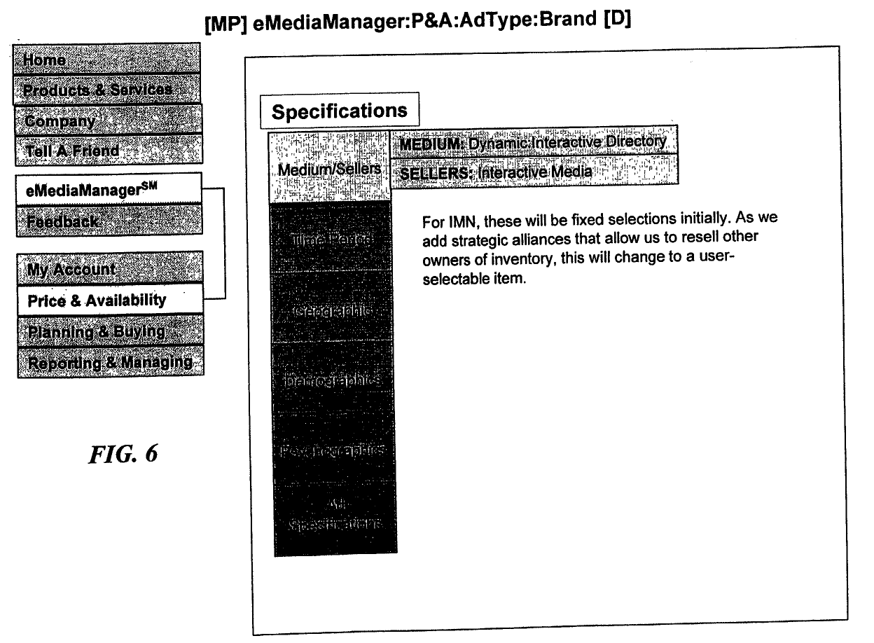

Referring now to FIG. 6, a screen presentation showing brand information is provided.

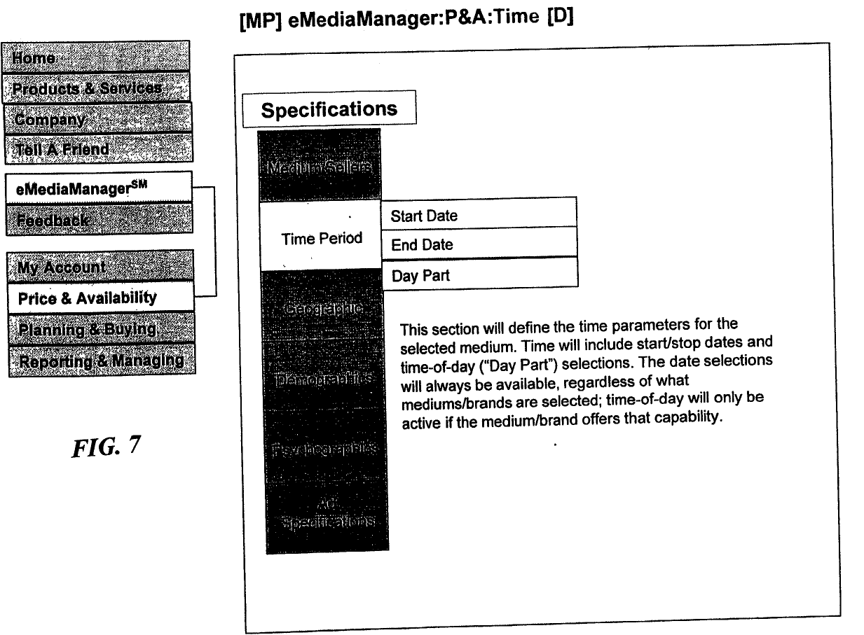

Referring now to FIG. 7, a screen presentation showing time information is provided. The time information preferably comprises a start date, and end date, and a day part or time of day during which the placement of advertising is desired.

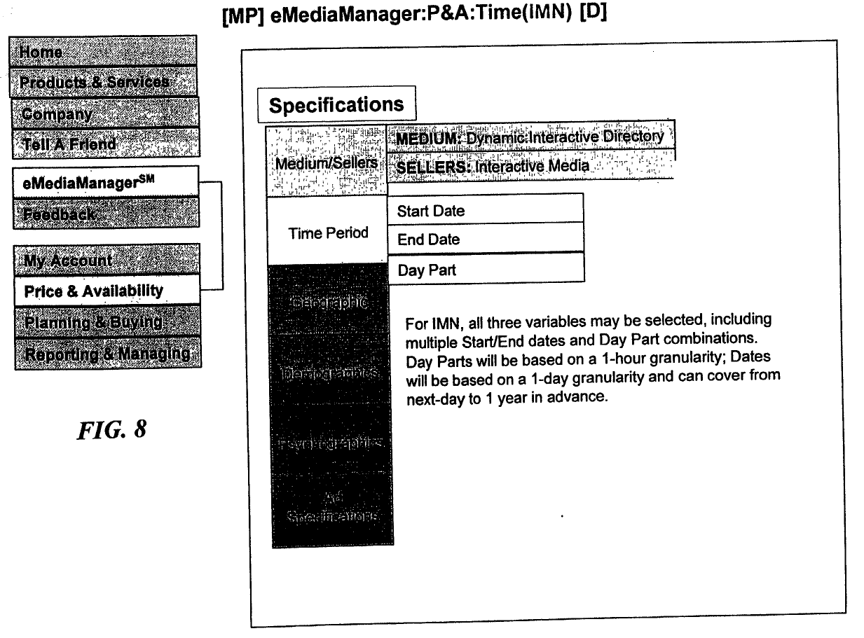

Referring now to FIG. 8, a screen presentation showing further time information is provided. Dates are preferably based on a one-day granularity and can cover from the next day to one year in advance.

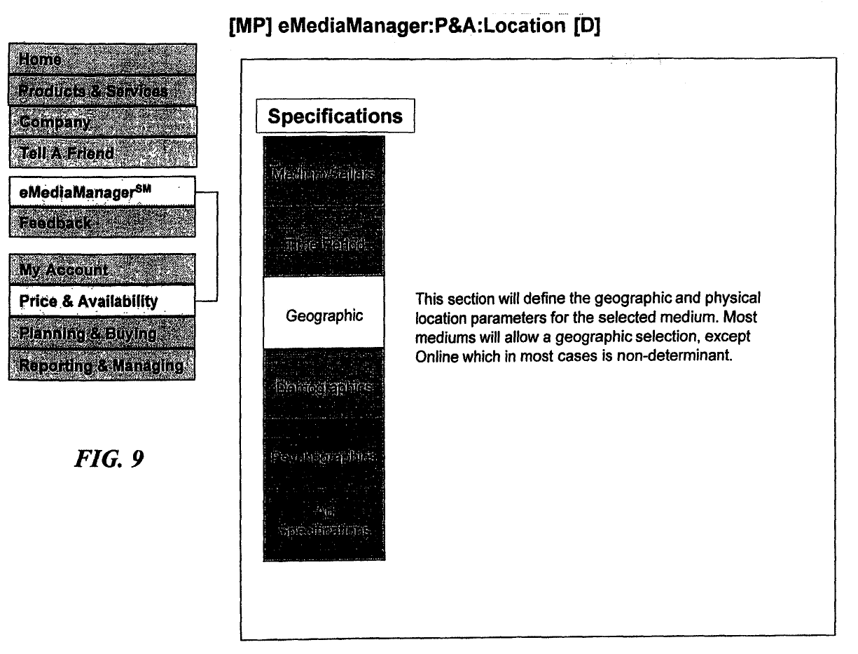

Referring now to FIG. 9, a screen presentation showing location information is provided. The location information preferably defines the geographic and physical location parameters for the selected medium. It is worthwhile to note that online content generally lacks geographic information. However, geographically oriented online content may be facilitated, if desired.

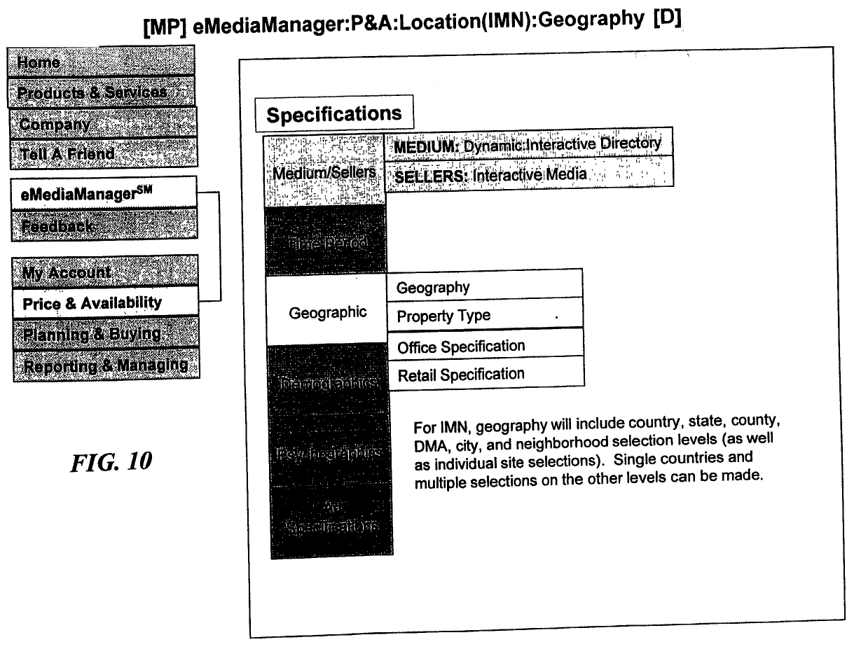

Referring now to FIG. 10, a screen presentation showing further geographic information is provided. Such geographic information preferably includes country, state, county, demographic metropolitan area (DMA), city and neighborhood selection levels, as well as individual site selections. Single countries and multiple selections on other levels can optionally be facilitated.

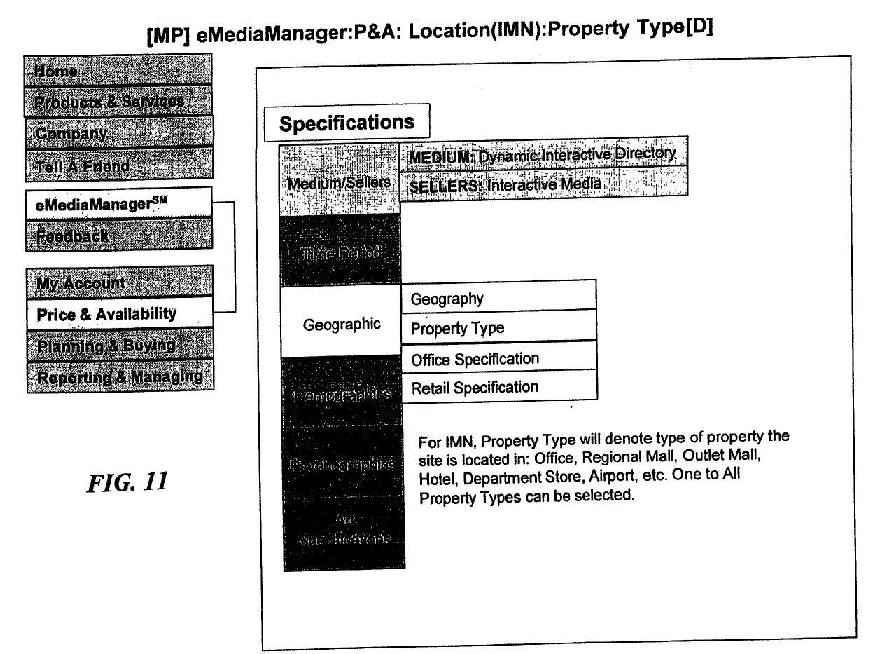

Referring now to FIG. 11, a screen presentation showing property type information. The property type denotes the type of property the site is located in. For example, office, regional mall, outlet mall, hotel, department store, and airport are all property types. A property type is selected so as to define where the advertising is to be placed.

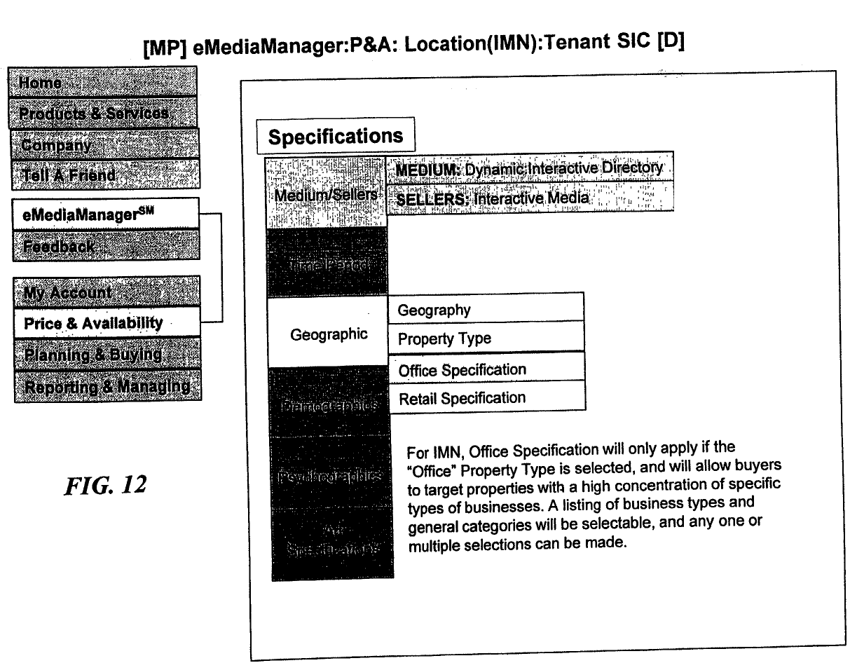

Referring now to FIG. 12, a screen presentation showing tenant SIC code is shown. Use of the SIC code facilitates targeting of properties with a high concentration of specific types of businesses. A listing of business types and general categories is selectable. Preferably, any single category or a selection of multiple categories may be facilitated.

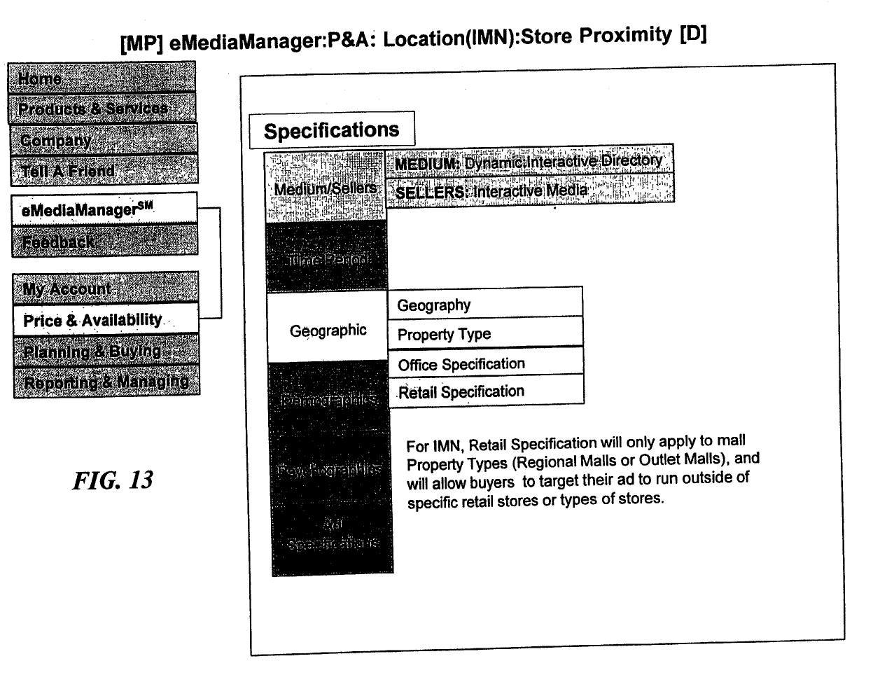

Referring now to FIG. 13, a screen presentation showing store proximity is provided. The screen will allow buyers to target their ad to run outside of specific retail stores or types of stores.

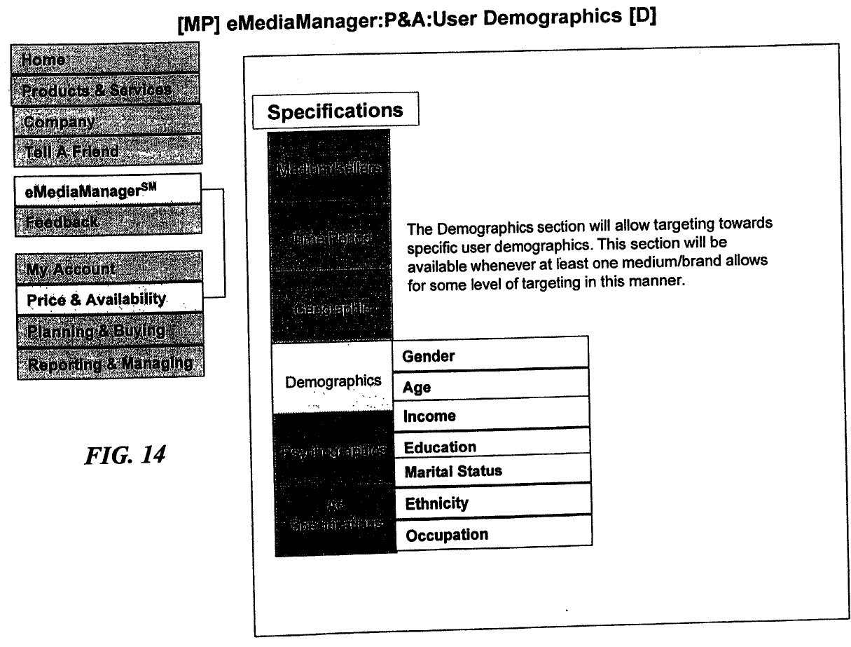

Referring now to FIG. 14, a screen presentation showing user demographics is provided. The demographics screen facilitates targeting of specified user demographics. This screen is typically provided when at least one medium/brand allows for some level of targeting according to demographics.

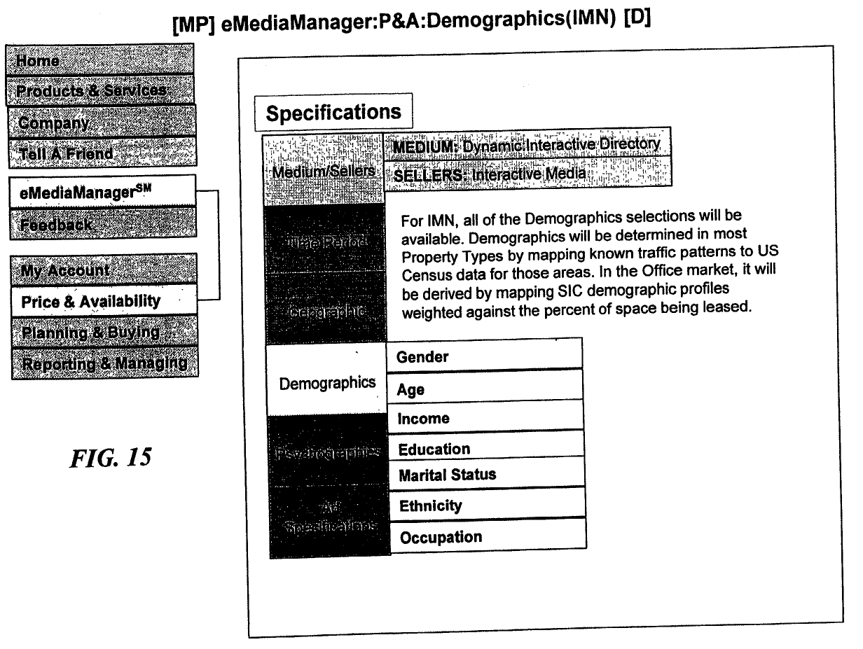

Referring now to FIG. 15, a screen presentation showing further demographic information is provided. Demographics can be determined in most property types by mapping known traffic patterns to U.S. Census data for those particular areas. In the office market, demographics can be derived by mapping SIC demographic profiles weighted against the percentage of space being leased.

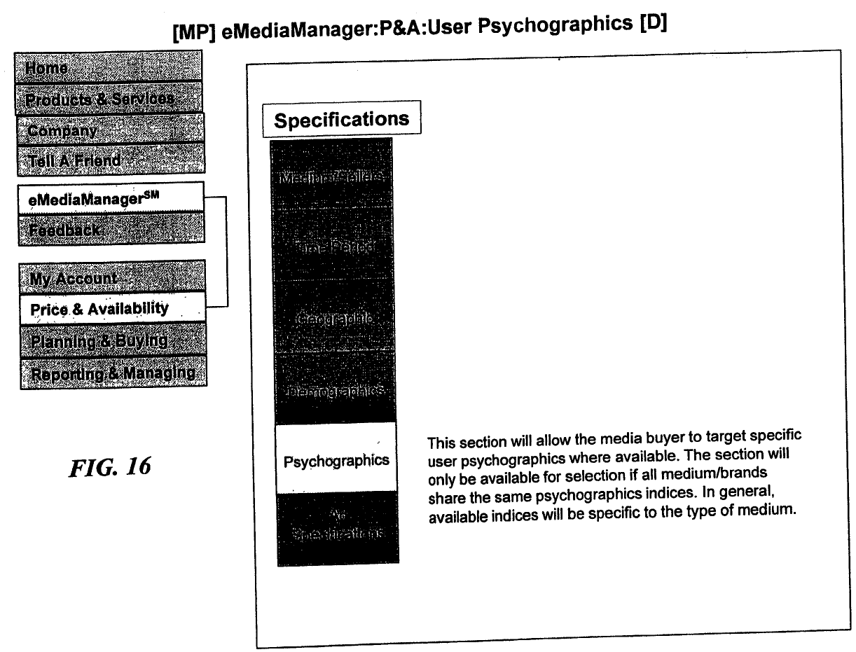

Referring now to FIG. 16, a screen presentation showing user psychographic information is provided. This screen allows the media buyer to target specific user psychographics, where available. This screen is preferably only available for selection if all medium/brands share the same psychographic indices. In general, available indices will be specific to the type of medium.

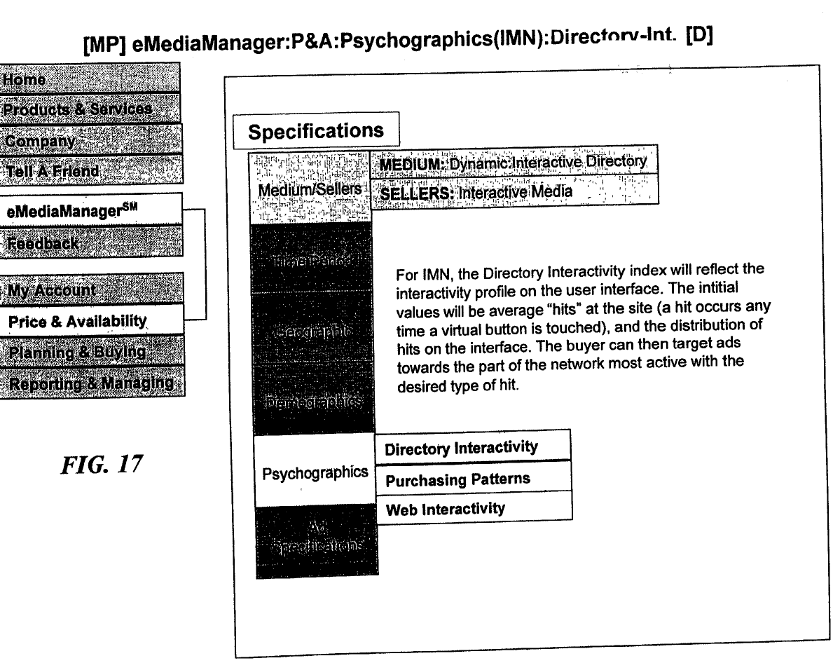

Referring now to FIG. 17, a screen presentation showing directory interactivity is provided. A directory interactivity index will reflect the interactivity profile of the user interface. The initial values will be average hits at the website (a hit occurs anytime a virtual button is touched), and the distribution of hits on the interface. The buyer can then target ads toward the part of the network most active with the desired type of hit.

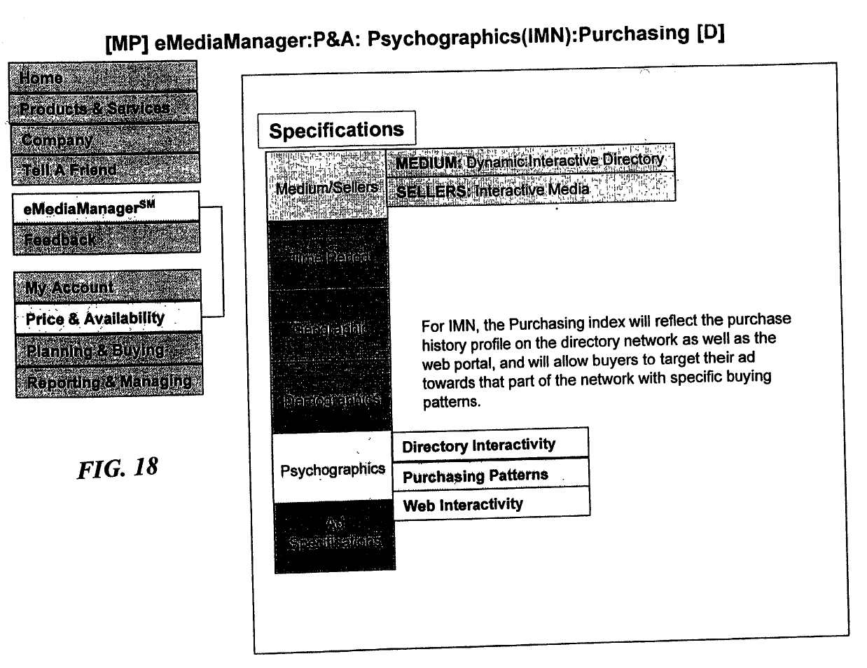

Referring now to FIG. 18, a screen presentation showing purchasing information is provided. A purchasing index preferably reflects the purchase history profile on the directory network, as well as the web portal, and preferably allows buyers to target their ad toward that part of the network with specific buying patterns.

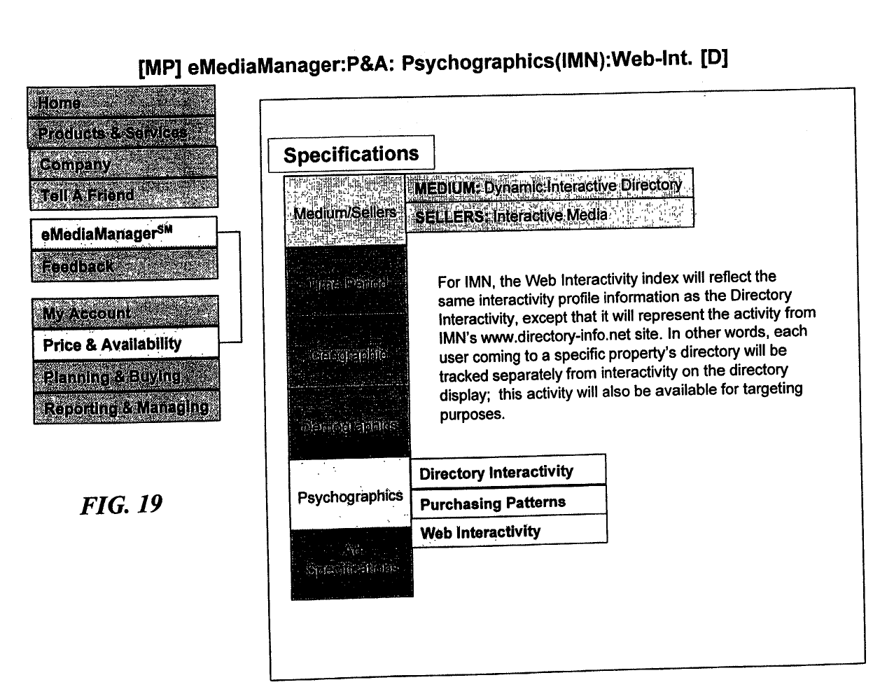

Referring now to FIG. 19, a screen presentation showing web interactivity is provided. A web interactivity index reflects the same interactivity profile information as the directory interactivity, except that it will represent the interactivity from a www.directoryinfo.net site. In other words, each user coming to a specific property's directory will be tracked separately from interactivity on the directory display. This interactivity will also be available for targeting purposes.

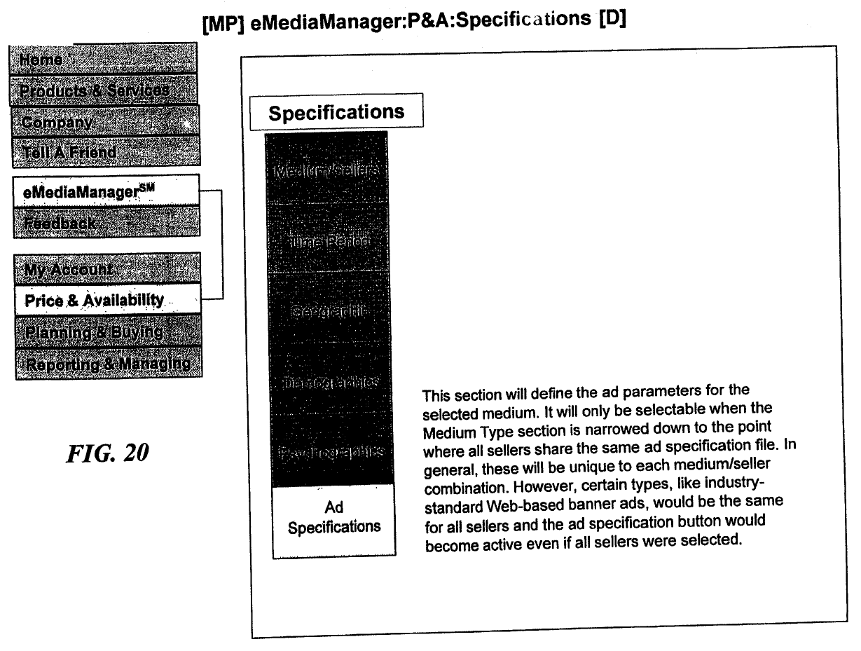

Referring now to FIG. 20, a screen presentation showing specification information is provided. This screen defines the ad parameters for the selected medium. It will only typically be selectable when the medium type selection is narrowed down to the point where all sellers share the same ad specification file. In general, these will be unique to each medium/seller combination. However, certain types, like industry-standard web based banner ads, will be the same for all sellers and the ad specification button will become active even if all sellers are selected.

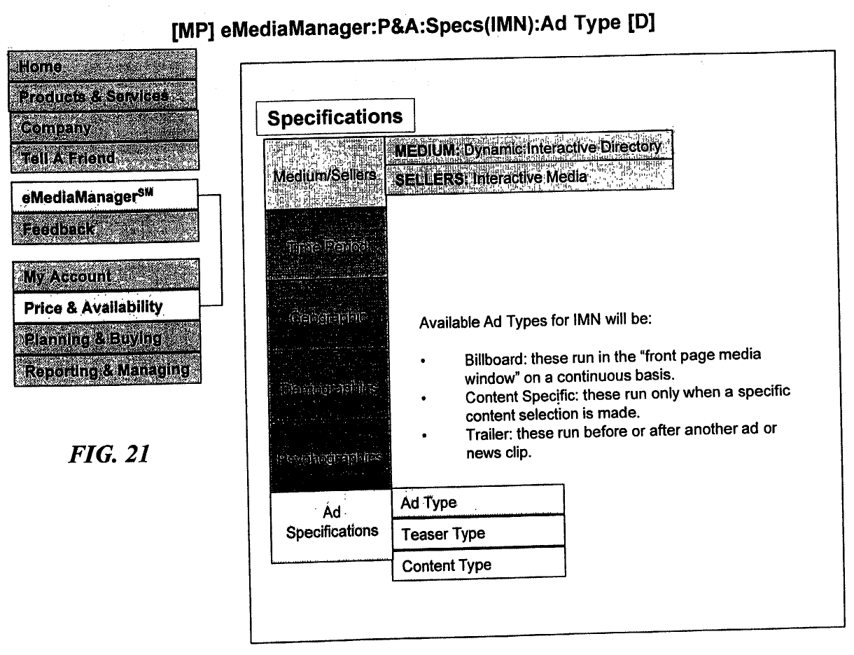

Referring now to FIG. 21, a screen presentation showing ad type information is provided. The available ad types are preferably: billboard (which run in the front page media window on a continuous basis); content specification (which run only when a specific content selection is made); and trailer (which run before or after another ad or news clip). Such ad types are particularly well suited for Internet or interactive media. However, those skilled in the art will appreciate that such ad types may be utilized on various different media, including television and radio.

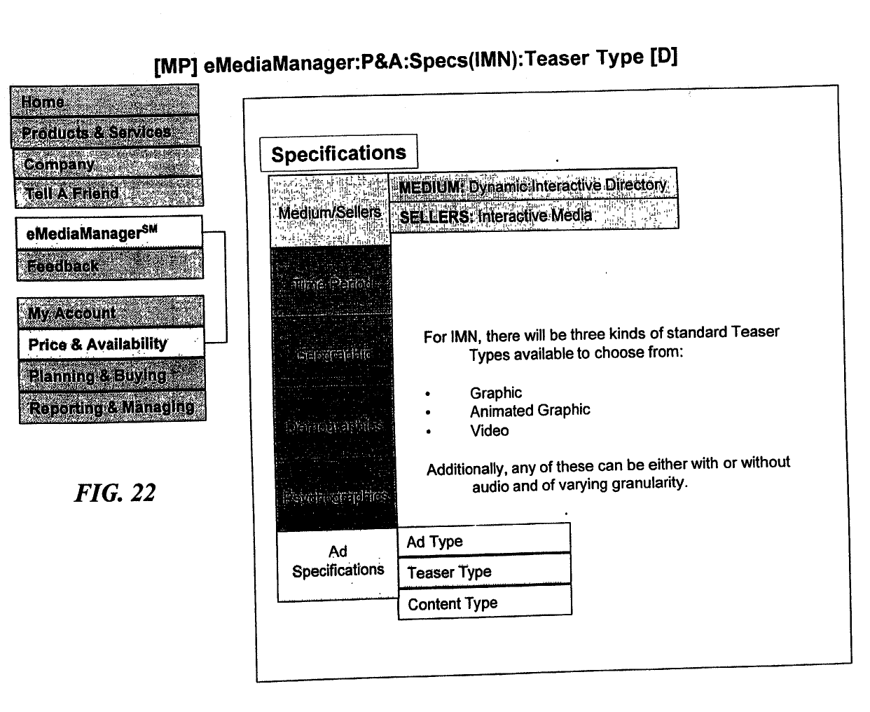

Referring now to FIG. 22, a screen presentation showing teaser type information is provided. There are preferably three kinds of standard teaser types to chose from, including graphic, animated graphic and video. Any of these types may be provided either with or without audio. Preferably, varying granularity is facilitated.

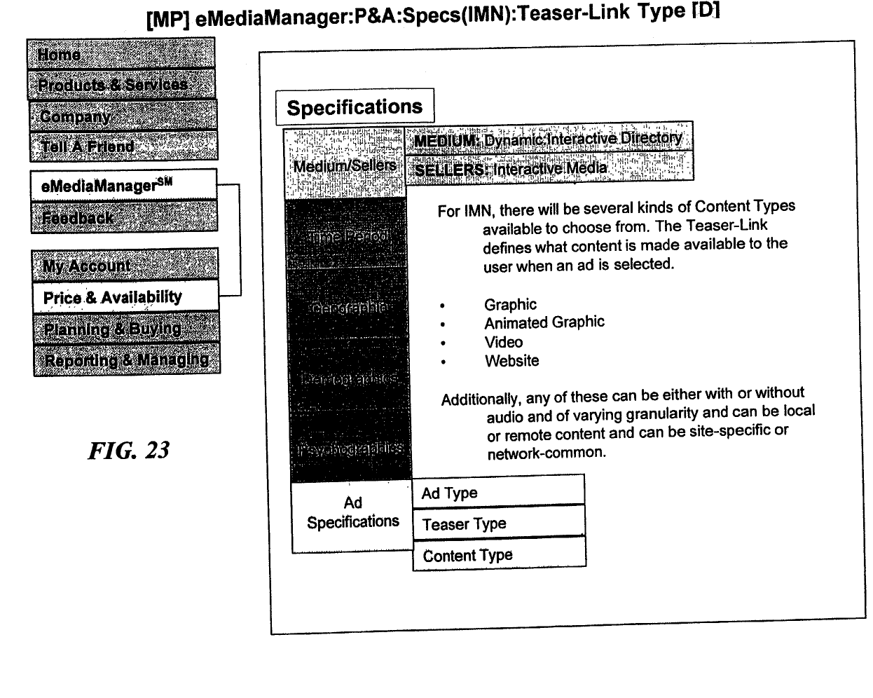

Referring now to FIG. 23, a screen presentation showing teaser-link type is provided. According to the present invention, there are several kinds of content types available to chose from. The teaser-link defines what content is made available to the user when an ad is selected. The content types include graphic, animated graphic, video and website.

Any of these content types may be utilized with or without audio and preferably may be facilitate with varying granularity. Local or remote content is preferably facilitated and the content can preferably be either site specific or network common.

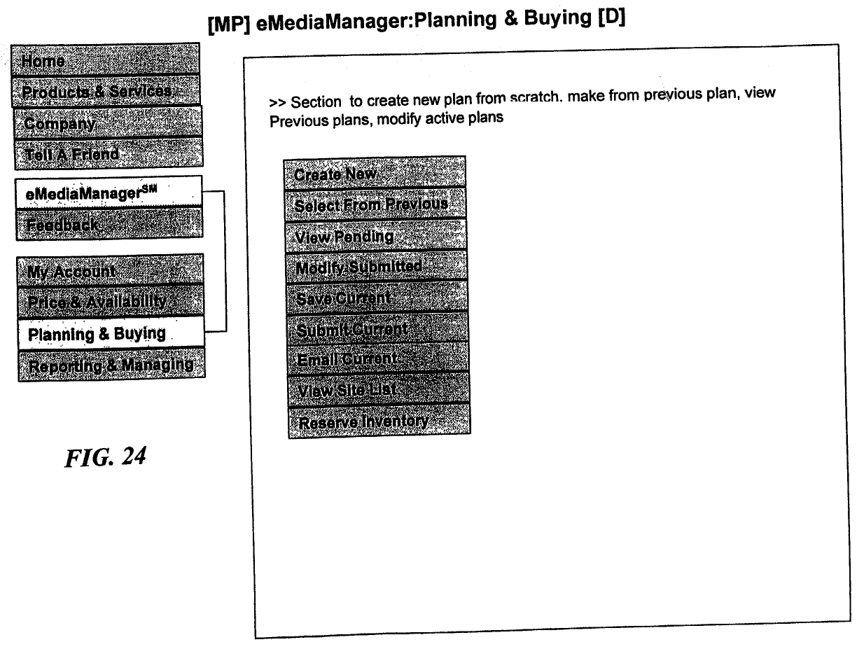

Referring now to FIG. 24, a screen presentation showing planning and buying information is provided. Selection from this screen facilitates the creation of new plans from scratch. Preferably, it is also possible to facilitate the creation of a new screen from a previous plan. The viewing of previous plans is facilitated and such previous plans may easily be modified.

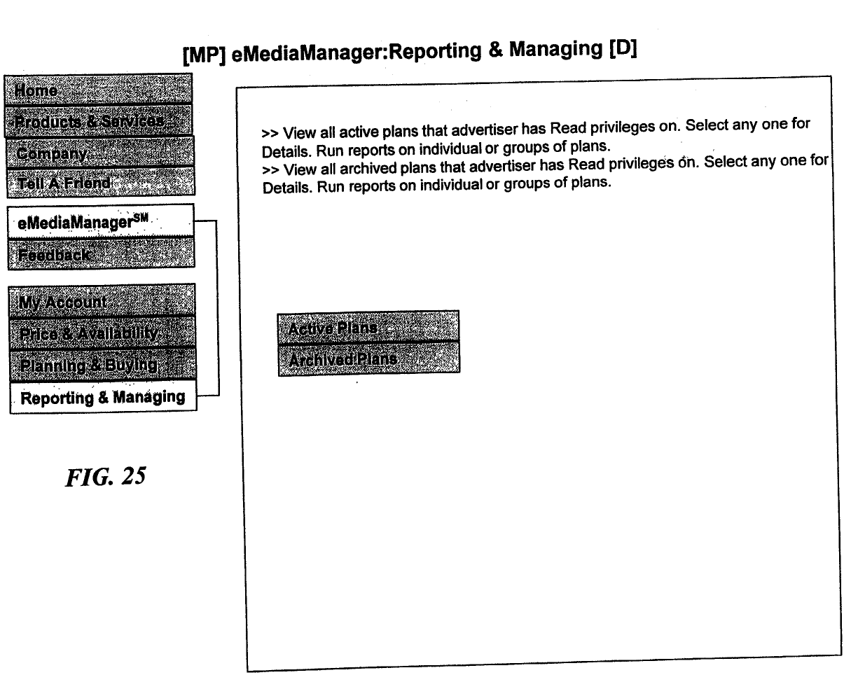

Referring now to FIG. 25, a screen presentation showing reporting and managing is provided. This screen allows viewing of all active plans which the advertiser has read privileges for. Any one of the plans may be selected so as to facilitate the viewing of additional details. Reports may be run on individual plans or on groups of plans.

This screen also preferably facilitates viewing of all archived plans which a particular advertiser has read privileges for. Again, any one of the plans may be selected so as to facilitate viewing of details and reports may be run on individual plans or groups of plans.

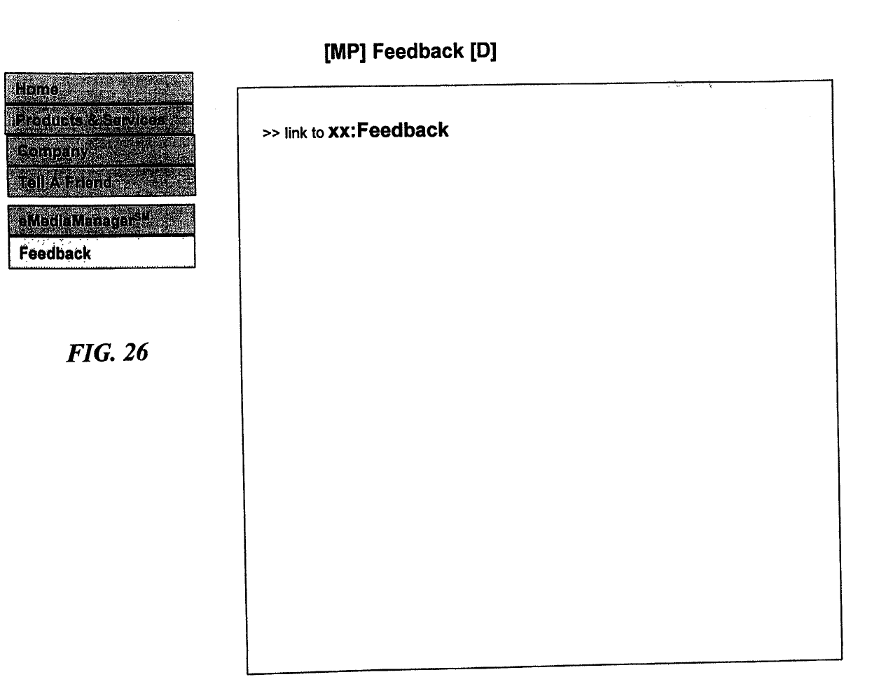

Referring now to FIG. 26, a screen presentation which facilitates the viewing of feedback is preferably provided.

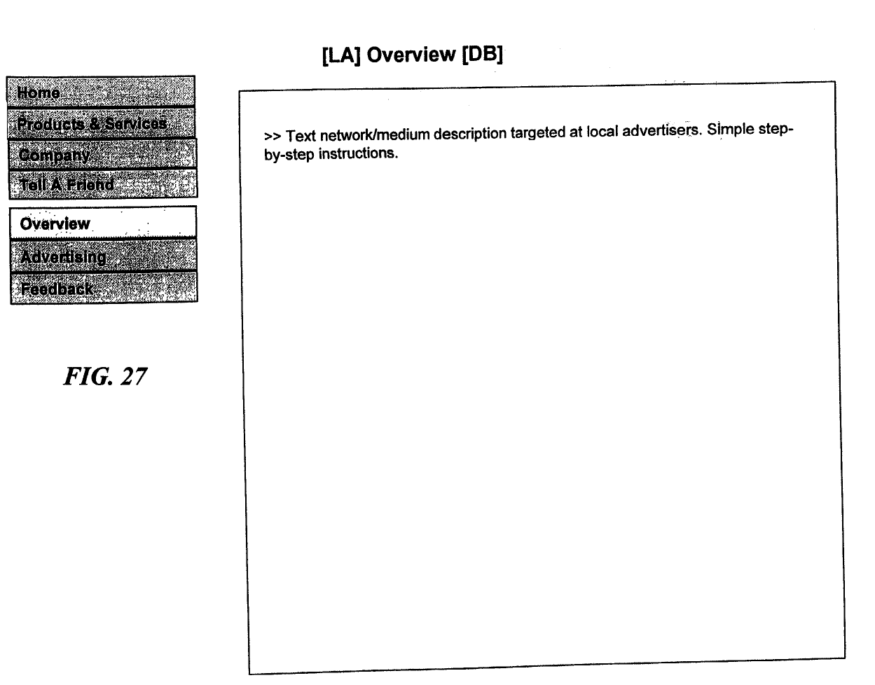

FIGS. 27 through 29 show screen presentations utilized by registered local advertisers. Registered local advertisers are those advertisers who participate in the interactive media management system of the present invention and who have been registered so as to facilitate access thereto.

Referring now to FIG. 27, a screen presentation showing an overview of the system is provided. The screen presentation preferably includes a textual network/medium description which is targeted at local advertisers. Simple step-by-step instructions are provided so as to facilitate use by local advertisers.

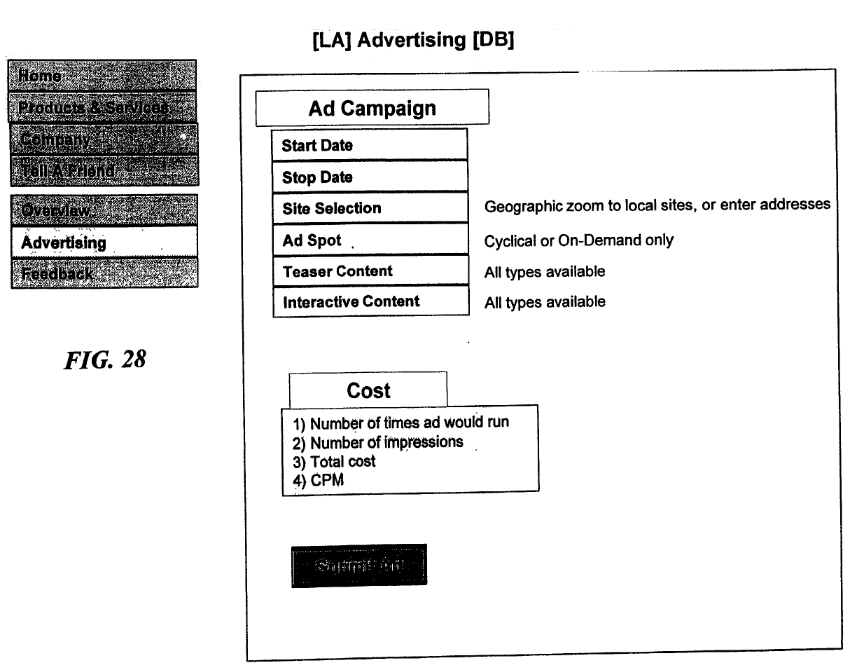

Referring now to FIG. 28, a screen presentation showing advertising is provided. This screen defines an ad campaign by, including information regarding, start date, stop date, site selection, ad spot, teaser content and interactive content. Costs are also provided and are preferably broken down by number of times the ad will run, number of impressions, total cost and cost per thousand (CPM).

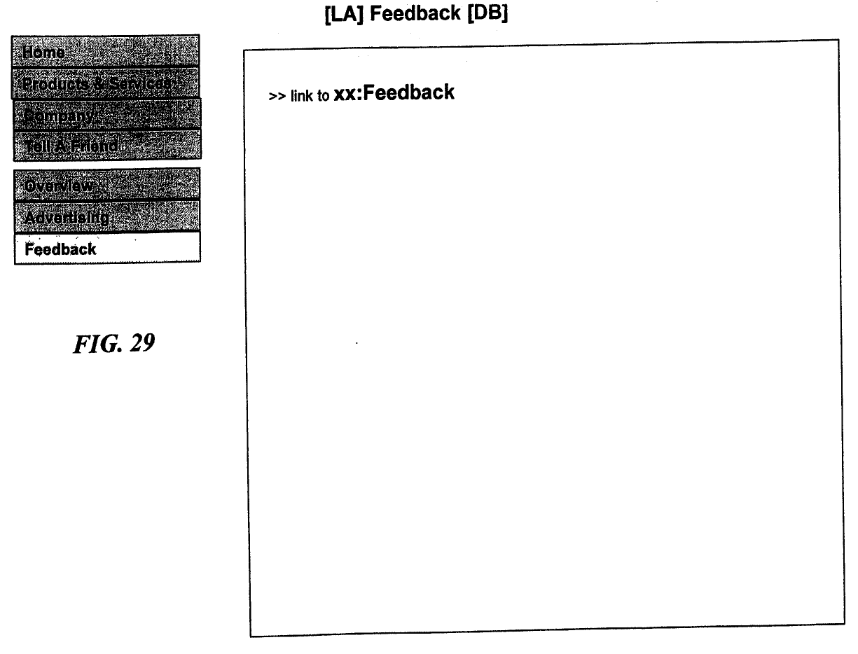

Referring now to FIG. 29, a screen presentation showing feedback for registered local advertisers is provided.

It is understood that the exemplary web-based media management system described herein and shown in the drawing represents only a presently preferred embodiment of the invention. Indeed, various modifications and additions may be made to such embodiment without departing from the spirit and scope of the invention. For example, those skilled in the art will appreciate various different marketing and advertising parameters are suitable for use in the decision making process as to the type of media, the timing of an advertising campaign, and the definition of a targeted audience. Thus, these and other modifications may be obvious to those skilled in the art and may be implemented to adapt the present invention for use in a variety of different applications.

What is claimed is:

1. A media management system comprising:
a web-based interface configured to:
provide substantially real-time media pricing;
provide substantially real-time media availability; and
facilitate substantially real-time buying of media.

2. The media management system as recited in claim 1, wherein the web-based interface is configured to:
provide substantially real-time media pricing for advertising;
provide substantially real-time media availability for advertising; and
facilitate substantially real-time buying of media for advertising.

3. The media management system as recited in claim 1, wherein the system is at least partially embedded into at least one inventory sales system of at least one media supplier.

4. The media management system as recited in claim 1, wherein the web-based interface is configured to use dynamic pricing models that are driven by a degree of targetability selected by a media buyer.

5. The media management system as recited in claim 1, wherein the web-based interface is further configured to provide real-time monitoring of selected performance statistics at least partially throughout a life of an advertising campaign.

6. The media management system as recited in claim 1, wherein the web-based interface is further configured to facilitate entry of a media plan profile thereunto.

7. The media management system as recited in claim 1, wherein the web-based interface is configured to translate media planing variables into pricing and availability for media inventory.

8. The media management system as recited in claim 1, wherein the web-based interface is configured to facilitate a real-time interactive process of modification and refinement by selecting media related variables and changing the selected variables.

9. The media management system as recited in claim 1, wherein the web-based interface is configured to facilitate purchasing of media by sending an electronic purchase order.

10. The media management system as recited in claim 1, wherein the web-based interface is configured to distribute request for proposals to a plurality of media suppliers who have inventory which matches a media plan profile.

11. A method for managing media, the method comprising:
using a web-based interface to provide substantially real-time media processing;
using the web-based interface to provide substantially real-time media availability; and
using the web-based interface to facilitate substantially real-time buying of media.

12. The method as recited in claim 11, wherein:
using the web-faced interface to provide substantially real-time pricing comprises using the web-based interface to provide substantially real-time pricing for advertising;
using the web-based interface to provide substantially real-time media availability comprising using the web-based interface to provide substantially real-time media availability for advertising; and
using the web-based interface to facilitate substantially real-time buying of media comprises using the web-based interface to facilitate substantially real-time buying of media for advertising.

13. The method as recited in claim 11, further comprising at least partially embedding a portion of a media management system into at least one inventory sales system of at least one media supplier.

14. The method as recited in claim 11, further comprising using dynamic pricing models which are driven by a degree of targetability by a media buyer.

15. The method as recited in claim 11, further comprising providing real-time monitoring of select performance statistics at least partially throughout an advertising campaign.

16. The method as recited in claim 11, further comprising providing entering of a media plan profile into the web-based interface.

17. The method as recited in claim 11, further comprising translating media planning variables into pricing and availability for media inventory.

18. The method as recited in claim 11, further comprising facilitating a real-time editorive process of modification and refinement by selecting media related variables and by changing the selected variables.

19. The method as recited in claim 11, further comprising facilitating purchasing of media by sending an electronic purchase order.

20. The method as recited in claim 11, further comprising distributing request for proposals to a plurality of media suppliers who have inventory which matches a media plan profile.
